(19) United States
(12) Patent Application Publication
(10) Pub. No.: US 2016/0368193 A1
(43) Pub. Date: Dec. 22, 2016

(54) MOLDING DIE AND MANUFACTURING METHOD USING MOLDING DIE

(71) Applicant: OLYMPUS CORPORATION, Tokyo (JP)

(72) Inventor: Isao TSUBOUCHI, Tokyo (JP)

(73) Assignee: OLYMPUS CORPORATION, Tokyo (JP)

(21) Appl. No.: 15/256,474

(22) Filed: Sep. 2, 2016

Related U.S. Application Data
(63) Continuation of application No. PCT/JP2015/056827, filed on Mar. 9, 2015.

(30) Foreign Application Priority Data
Mar. 7, 2014 (JP) 2014-045535

(51) Int. Cl. B29C 45/40

(52) U.S. Cl. CPC B29C 45/401; B29C 2045/4057; B29L 2011/0016

(57) ABSTRACT

A movable side die of a molding die includes a movable side sleeve and a movable side molding die unit which is accommodated in the movable side sleeve, and molds a molded article together with a fixed side molding die. The movable side die further includes a projecting mechanism which detachably abuts on a part of a proximal end surface of the movable side molding die unit so that a distal end surface of the movable side molding die unit is projected from a distal end surface of the movable side sleeve toward the fixed side molding die, and projects the movable side molding die unit toward the fixed side molding die to the movable side sleeve from an abutting state.

### CROSS-REFERENCE TO RELATED APPLICATIONS

This application is a Continuation application of PCT Application No. PCT/JP2015/056827, filed Mar. 9, 2015 and based upon and claiming the benefit of priority from prior Japanese Patent Application No. 2014-045535, filed Mar. 7, 2014, the entire contents of all of which are incorporated herein by reference.

### BACKGROUND OF THE INVENTION

1. Field of the Invention

The present invention relates to a molding die to mold molded articles and a manufacturing method using the molding die.

2. Description of the Related Art

For example, Jpn. Pat. Appln. KOKAI Publication No. H 9-267362 and Jpn. Pat. Appln. KOKAI Publication No. 2013-78869 disclose molding dies to mold molded articles having a high eccentric accuracy. Each molded article has an optical element such as a lens.

A movable side die of this molding die has a movable side sleeve and a movable side molding die which is arranged in the movable side sleeve and configured to mold a molded article together with a fixed side die. The movable side molding die is highly accurately fitted to the movable side sleeve, and hence a clearance between the movable side molding die and an inner peripheral surface of the movable side sleeve is as small as possible.

In this state, the movable side molding die is fitted to a distal end portion of a shaft-like projecting member on a proximal end surface of the movable side molding die. In this case, for example, an outer peripheral surface of the distal end portion of the projecting member is closely contacted with an inner peripheral surface of a groove portion arranged on the proximal end surface of the movable side molding die. Further, a proximal end portion of the projecting member is supported by an ejector plate. That is, the movable side molding die, the projecting member, and the ejector plate are integrated with each other.

When the ejector plate is pressed, the ejector plate pushes out the projecting member along an axial direction of the movable side die. Consequently, the projecting member is to project the movable side molding die to the movable side sleeve toward the fixed side die. Thus, a distal end surface of the movable side molding die is projected from a distal end surface of the movable side sleeve, and the molded article is taken out by this projection.

As described above, the projecting member and the ejector plate function as a projecting mechanism which pushes out the molded article, in other words, projects the molded article.

### BRIEF SUMMARY OF THE INVENTION

An aspect of a molding die of the present invention includes a fixed side die; and a movable side die which is arranged to face the fixed side die and is movable to close or open to the fixed side die, the movable side die includes a movable side sleeve; a movable side molding die unit which is accommodated in the movable side sleeve, and molds a molded article together with a fixed side molding die of the fixed side die; and a projecting mechanism which detachably abuts on a part of a proximal end surface of the movable side molding die unit so that a distal end surface of the movable side molding die unit is projected from a distal end surface of the movable side sleeve toward the fixed side molding die, and projects the movable side molding die unit toward the fixed side molding die to the movable side sleeve from an abutting state.

An aspect of a manufacturing method of the present invention uses the molding die and includes a projecting process of projecting the movable side molding die unit toward the fixed side molding die by the projecting mechanism to the movable side sleeve from a state where the projecting mechanism abuts on a part of a proximal end surface of the movable side molding die unit so that a distal end surface of the movable side molding die unit is projected toward the fixed side molding die from a distal end surface of the movable sleeve in the movable side molding die unit which is accommodated in the movable side sleeve and molds the molded article.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view of a molded article according to a first embodiment of the present invention;

FIG. 2 is a front view of a movable side die of a molding die according to the first embodiment when the number of the molded articles to be taken out is one;

FIG. 3A is a view showing a cross section taken along a line 3A-3A depicted in FIG. 2 and also showing a state where the movable side die is closed to a fixed side die and the molded article is molded;

FIG. 3B is a view showing a state where the movable side die is opened to the fixed side die from the state shown in FIG. 3A;

FIG. 3C is a view showing a state where the molded article is projected by a projecting mechanism from the state shown in FIG. 3B;

FIG. 4 is a front view of the movable side die of a molding die according to the first embodiment when the number of molded articles to be taken out is four;

FIG. 5A is a view showing a cross section taken along the line 3A-3A depicted in FIG. 2 and also showing a state where the movable side die is closed to the fixed side die and an article is molded, which is a first modification of the first embodiment; and

FIG. 5B is a view showing a cross section taken along the line 3A-3A depicted in FIG. 2 and also showing a state where the movable side die is closed to the fixed side die and an article is molded, which is a second modification of the first embodiment.

### DETAILED DESCRIPTION OF THE INVENTION

Hereinafter, an embodiment according to the present invention will now be described in detail with reference to the drawings.

### First Embodiment

### Configuration

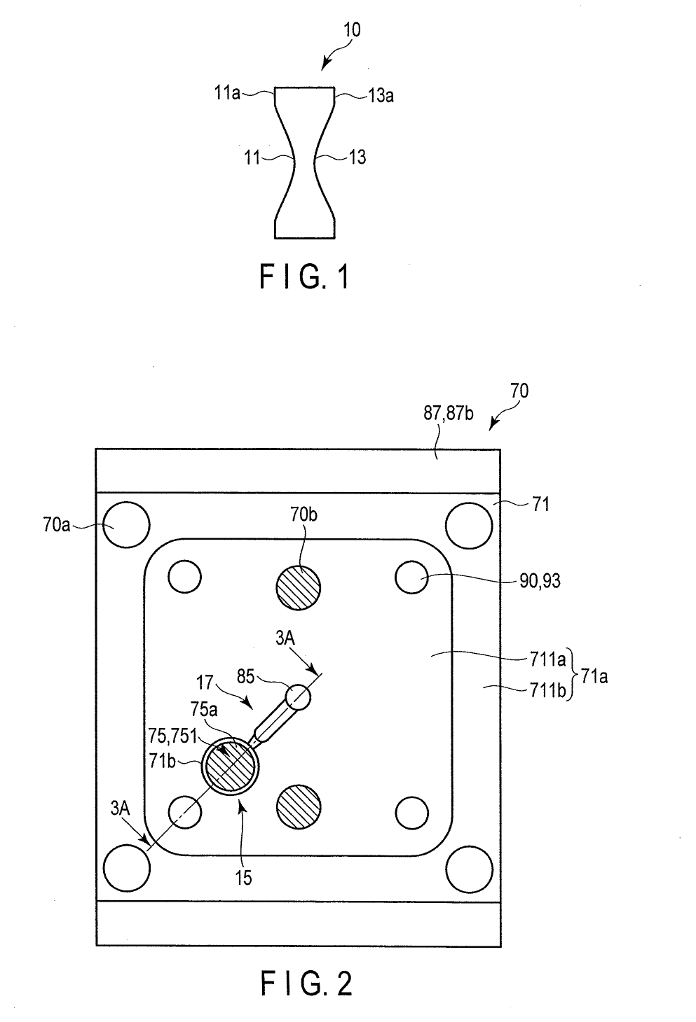

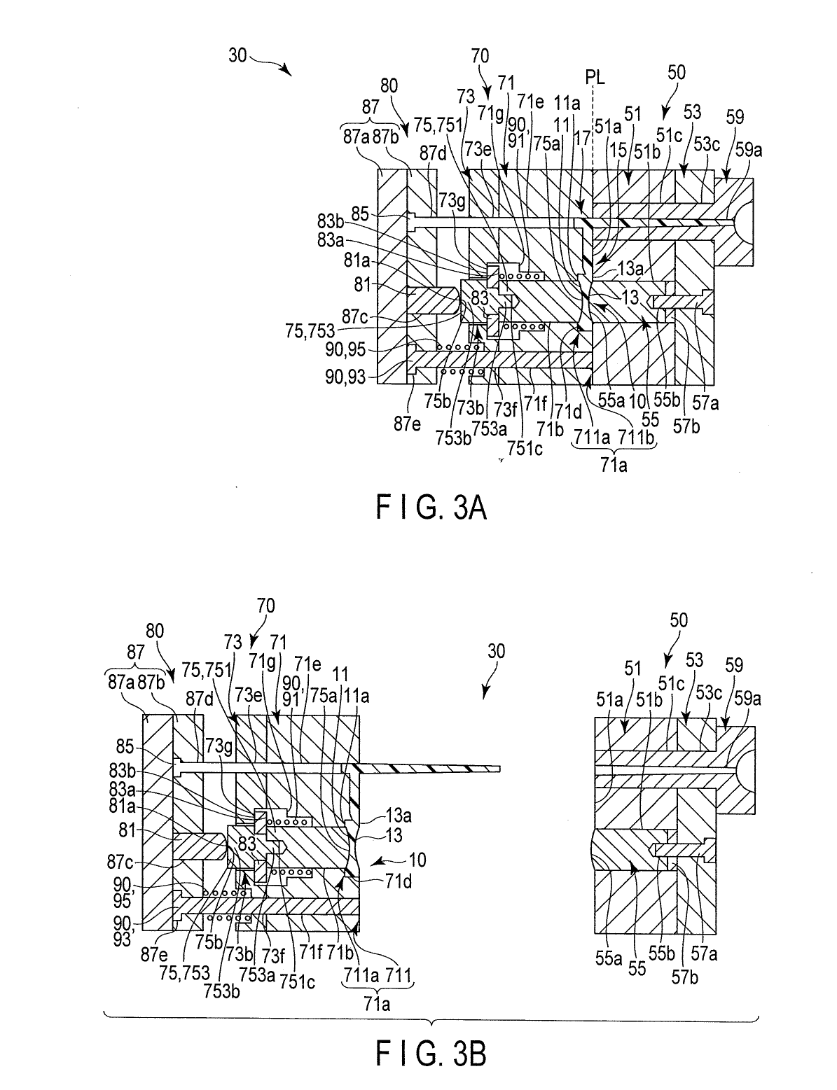

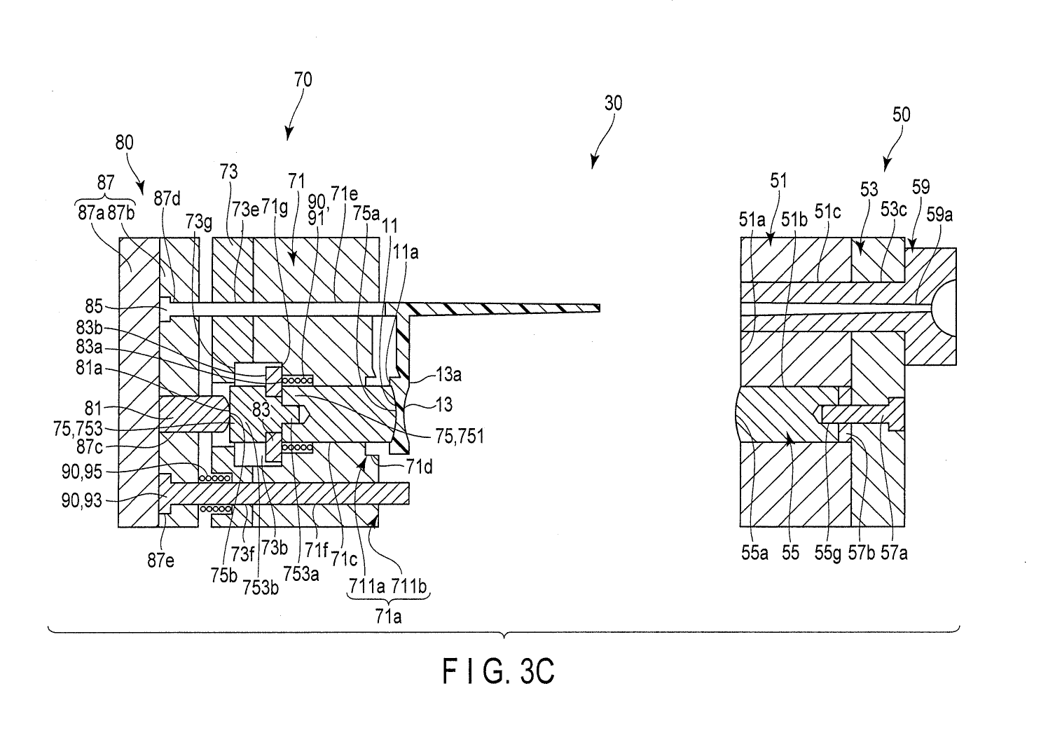

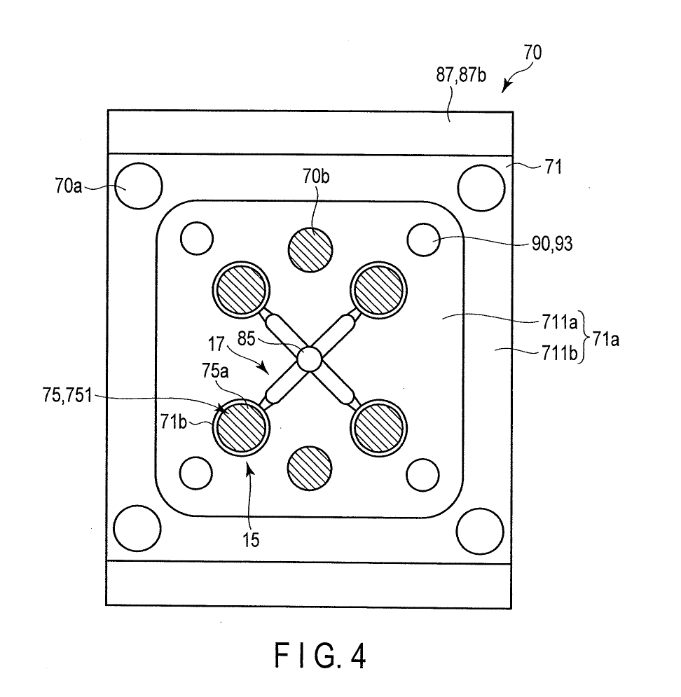

A first embodiment will now be described with reference to FIG. 1, FIG. 2, FIG. 3A, FIG. 3B, FIG. 3C, and FIG. 4. It is to be noted that, in some drawings, to clarify graphic representations, some members are omitted.

[Molded Article 10]

Such a molded article 10 as shown in FIG. 1 is injection-molded by a molding die 30 which is such a molding apparatus as shown in FIG. 2, FIG. 3A, FIG. 3B, FIG. 3C, and FIG. 4. Such a molded article 10 includes optical components such as a resin lens mounted in, e.g., a camera. The molded article 10 is molded by using a transparent resin material through which light can be transmitted. Such a material includes, for example polycarbonate or the like.

As shown in FIG. 1, the molded article 10 has a first optical functional surface 11 and a second optical functional surface 13. Furthermore, as shown in FIG. 1, the molded article 10 also has a flange-shaped first edge portion 11a formed at an outer peripheral region of the second optical functional surface 11, and a flange-shaped second edge portion 13a formed at an outer peripheral region of the second optical functional surface 13. The first optical functional surface 11 and the first edge portion 11a function as a back surface of the molded article 10, and are formed of a movable side die 70. The second optical functional surface 13 and the second edge portion 13a function as a front surface of the molded article 10, and are formed of, e.g., a fixed side die 50.

As shown in FIG. 1, the first optical functional surface 11 is recessed toward the second optical functional surface 13 in a plane direction of the back surface of the molded article 10. The second optical functional surface 13 is recessed toward the first optical functional surface 11 in a plane direction of the front surface of the molded article 10.

[Molding Die 30]

As shown in FIG. 2, FIG. 3A, FIG. 3B, and FIG. 3C, the molding die 30 has a fixed side die 50 and a movable side die 70 which is arranged to face the fixed side die 50 and can move to close (get close) to or open to (get away from) the fixed side die 50. The fixed side die 50 is disposed to a non-illustrated first platen section of a non-illustrated injection molding machine, and the movable side die 70 is disposed to a non-illustrated second platen section of the injection molding machine. The fixed side die 50 and the movable side die 70 are arranged to face each other to sandwich a parting line (PL) therebetween. In this state, the movable side die 70 is supported by the second platen section so that the movable side die 70 can move to the fixed side die 50 in an opening/closing direction (a left-and-right direction in FIG. 3A).

As shown in FIG. 3A, in this embodiment, when the fixed side die 50 and the movable side die 70 are combined so that the movable side die 70 can be closed to the fixed side die 50, for example, one molding cavity portion 15 and one flow channel portion 17 are formed. The flow channel portion 17 communicates with the molding cavity portion 15, and allows a material of the molded article 10 to flow therethrough to the molding cavity portion 15. The molding cavity portion 15 is formed as a space portion which defines a shape of the molded article 10. The molding cavity portion 15 has a fixed side cavity portion arranged in the fixed side die 50 and a movable side cavity portion arranged in the movable side die 70. The fixed side cavity portion and the movable side cavity portion face each other. The flow channel portion 17 is defined by a distal end surface 51a of a fixed side sleeve 51 arranged in the fixed side die 50 and a distal end surface 71a of a movable side sleeve 71 which faces the distal end surface 51a and is arranged in the movable side die 70. Details of the molding cavity portion 15 and the flow channel portion 17 will be described later.

The molding die 30 defines a shape of the molded article 10 when the material of the molded article 10 is injected into the molding cavity portion 15.

The number of the molded articles 10 molded by the molding die 30 is, e.g., one as shown in FIG. 2, FIG. 3A, FIG. 3B, and FIG. 3C, but this number does not have to be restricted, and it may be four as shown in FIG. 4 or a plural number. The number of the molding cavity portions 15 is the same as the number of the flow channel portions 17, and the number of the flow channel portions 17 is the same as the number of the molded articles 10 molded by the molding die 30.

[Fixed Side Die 50]

As shown in FIG. 3A, FIG. 3B, and FIG. 3C, the fixed side die 50 has the fixed side sleeve 51 which faces the movable side sleeve 71 of the movable side die 70, and a fixed side backing plate 53 on which the fixed side sleeve 51 is mounted. The fixed side die 50 further has a fixed side molding die 55 accommodated in the fixed side sleeve 51, and a sprue bush 59. The fixed side sleeve 51, the fixed side backing plate 53, the fixed side molding die 55, and the sprue bush 59 are, e.g., metals.

[Fixed Side Sleeve 51]

Such a fixed side sleeve 51 as shown in FIG. 3A, FIG. 3B, and FIG. 3C is fixed to the fixed side backing plate 53 by a non-illustrated bolt or the like, and is integrated with the fixed side backing plate 53. The integrated fixed side sleeve 51 and the fixed side backing plate 53 are positioned and fixed to a first mold base by non-illustrated fixed side guide pins, bolts, or similar fitted and inserted into the non-illustrated first mold base.

As shown in FIG. 3A, FIG. 3B, and FIG. 3C, the distal end surface 51a of the fixed side sleeve 51 faces the movable side sleeve 71 of the movable side die 70. The distal end surface 51a forms the fixed side cavity portion.

The fixed side sleeve 51 has a fixed side accommodating portion 51b which accommodates the fixed side molding die 55. The fixed side accommodating portion 51b accommodates the fixed side molding die 55 so that, for example, the distal end surface 51a of the fixed side sleeve 51 is arranged on the same plane as a distal end surface 55a of the fixed side molding die 55. The fixed side accommodating portion 51b functions as a hole portion into which the fixed side molding die 55 is fitted and inserted and which pierces through the fixed side sleeve 51 in the axial direction of the fixed side sleeve 51. The fixed side accommodating portion 51b is arranged along the axial direction of the fixed side die 50. The axial direction of the fixed side die 50 means the opening/closing direction of the movable side die 70.

Furthermore, the fixed side sleeve 51 also has a sleeve side insertion opening portion 51c which is arranged along the axial direction of the fixed side die 50 and into which the sprue bush 59 is fitted and inserted. The sleeve side insertion opening portion 51c functions as a hole portion.

[Fixed Side Backing Plate 53]

As shown in FIG. 3A, FIG. 3B, and FIG. 3C, the fixed side backing plate 53 has a backing plate side insertion opening portion 53c which is arranged along the axial direction of the fixed side die 50 and into which the sprue bush 59 is fitted and inserted. The backing plate side insertion opening portion 53c functions as a hole portion. It is to be noted that the fixed side sleeve 51 is mounted on the fixed side backing plate 53 so that the sleeve side insertion opening portion 51c communicates with the backing plate side insertion opening portion 53c in the axial direction of the fixed side die 50.

[Fixed Side Molding Die 55]

As shown in FIG. 3A, FIG. 3B, and FIG. 3C, the fixed side molding die 55 functions as a bush. The fixed side molding die 55 is arranged along the axial direction of the fixed side die 50. The fixed side molding die 55 is, e.g., a shaft-like member. The distal end surface 55a of the fixed side molding die 55 faces a distal end surface 75a of a later-described movable side molding die unit 75. The distal end surface 55a of the fixed side molding die 55 functions as a transfer surface which transfers the second optical functional surface 13 to the material which molds the molded article 10. It is to be noted that the distal end surface 51a of the fixed side sleeve 51 is arranged around the distal end surface 55a of the fixed side molding die 55. The distal end surface 51a functions as a transfer surface which transfers the second edge portion 13a to the material molding the molded article 10.

As shown in FIG. 3A, FIG. 3B, and FIG. 3C, the fixed side molding die 55 is fitted and inserted into the fixed side accommodating portion 51b. Thus, a clearance between an outer peripheral surface of the fixed side molding die 55 and an inner peripheral surface of the fixed side sleeve 51 in the fixed side accommodating portion 51b is extremely small.

As shown in FIG. 3A, FIG. 3B, and FIG. 3C, the fixed side molding die 55 is fixed by a fixing member 57a so that the distal end surface 51a of the fixed side sleeve 51 can be arranged on the same plane as the distal end surface 55a of the fixed side molding die 55 in a state where the fixed side molding die 55 is accommodated in the fixed side accommodating portion 51b as described above. A distal end portion of the fixing member 57a is inserted into the fixed side backing plate 53, and fitted in a groove portion 55b arranged at the proximal end portion of the fixed side molding die 55. The groove portion 55b is arranged on a planar proximal end surface of the proximal end portion. It is to be noted that, since arranging the distal end surface 51a of the fixed side sleeve 51 on the same plane as the distal end surface 55a of the fixed side molding die 55 can suffice, a spacer member 57b may be arranged between the proximal end portion of the fixed side molding die 55 and the fixed side backing plate 53. The fixing member 57a has, e.g., a screw.

[Sprue Bush 59]

As shown in FIG. 3A, FIG. 3B, and FIG. 3C, the sprue bush 59 is fitted and inserted into a sleeve side insertion opening portion 51b and a backing plate side insertion opening portion 53c. The sprue bush 59 has an inner flow channel portion 59a which is arranged inside the sprue bush 59 and through which the material molding the molded article 10 flows. The inner flow channel portion 59a is arranged along, e.g., the axial direction of the fixed side die 50. The inner flow channel portion 59a communicates with the flow channel portion 17. It is to be noted that the material flowing through the inner flow channel portion 59a is molten. The molten material flows from the inner flow channel portion 59a into the molding cavity portion 15a via the flow channel portion 17. Such a sprue bush 59 has a tubular shape, e.g., a cylindrical shape.

[Movable Side Die 70]

As shown in FIG. 3A, FIG. 3B, and FIG. 3C, the movable side die 70 has the movable side sleeve 71 facing the fixed side sleeve 51, and a movable side backing plate 73 on which the movable side sleeve 71 is mounted. The movable side die 70 further has a movable side molding die unit (which will be referred to as a unit 75 hereinafter) which is accommodated in the movable side sleeve 71 and molds the molded article 10 together with the fixed side molding die 55 of the fixed side die 50. The movable side sleeve 71, the movable side backing plate 73, and the unit 75 are, e.g., metals.

Further, as shown in FIG. 3A, FIG. 3B, and FIG. 3C, the movable side die 70 also has a projecting mechanism 80 which projects the unit 75 including the molded article 10 toward the fixed side molding die 55 to the movable side sleeve 71 from a state where the projecting mechanism 80 abuts on a part of a proximal end surface 75b of the unit 75. The movable side die 70 further has a return mechanism 90 which returns the unit 75 projected by the projecting mechanism 80 to a state before projection. When the projecting mechanism 80 is returned to the state before projection by the return mechanism 90, the projecting mechanism 80 can be separated from a part of the proximal end surface 75b by the return mechanism 90. The projecting mechanism 80 and the return mechanism 90 are, e.g., metals.

[Movable Side Sleeve 71]

Such a movable side sleeve 71 as shown in FIG. 2, FIG. 3A, FIG. 3B, and FIG. 3C is fixed to the movable side backing plate 73 by a non-illustrated bolt or the like, and integrated with the movable side backing plate 73. The integrated movable side sleeve 71 and movable side backing plate 73 are positioned and fixed to a second mold base by a movable side guide pin 70a (see FIG. 2), a bolt, or the like fitted and inserted into the non-illustrated second mold base. Furthermore, such a movable side sleeve 71 as shown in FIG. 2, FIG. 3A, FIG. 3B, and FIG. 3C is positioned to the fixed side sleeve 51 when a movable side positioning pin 70b (see FIG. 2) is fitted and inserted into the movable sleeve 71 and the movable side positioning pin 70b is detachably engaged with a non-illustrated fixed side positioning pin. The fixed side positioning pin is arranged along the axial direction of the fixed side die 50, and fitted and inserted into the fixed side sleeve 51. The movable side guide pin 70a and the movable side positioning pin 70b are arranged along the axial direction of the movable side die 70. The axial direction of the movable side die 70 means the opening/closing direction of the movable side die 70.

As shown in FIG. 3A, FIG. 3B, and FIG. 3C, the distal end surface 71a of the movable side sleeve 71 faces the distal end surface 51a of the fixed side sleeve 51. As shown in FIG. 3A, in this embodiment, for example, the molding cavity portion 15 and the flow channel portion 17 are formed when the movable side die 70 is closed to the fixed side die 50. Thus, a part 711a of the distal end surface 71a of the movable side sleeve 71 is recessed toward the projecting mechanism 80, namely, an opening direction of the movable side die 70 to the other part 711b of the distal end surface 71a of the movable side sleeve 71.

As shown in FIG. 3A, the flow channel portion 17 communicates with the inner flow channel portion 59a of the sprue bush 59, and is arranged to flow the material forming the molded article 10 into the molding cavity portion 15. The flow channel portion 17 is defined by the part 711a of the distal end surface 71a and a part of the distal end surface 51a which faces the part 711a. When the movable side die 70 is closed to the fixed side die 50, the part 711a is arranged away from a part of the distal end surface 51a arranged on the PL or, in more detail, arranged on a left side of the PL in the drawing. Thus, in this embodiment, the flow channel portion 17 and the molding cavity portion 15 are arranged on, e.g., the left side in the drawing.

As shown in FIG. 3A, when the movable side die 70 is closed to the fixed side die 50 and the flow channel portion 17 and the molding cavity portion 15 are formed, the other part 711b of the distal end surface 71a abuts on the other part of the distal end surface 51a. In this embodiment, the other part of the distal end surface 51a and the other part 711b are arranged on, e.g., the PL.

Moreover, as shown in FIG. 3A, FIG. 3B, and FIG. 3C, the movable side sleeve 71 has a recessed portion 71d which is arranged on the part 711a of the distal end surface 71a of the movable side sleeve 71 and arranged to form the first edge portion 11a.

Additionally, as shown in FIG. 3A, FIG. 3B, and FIG. 3C, the movable side sleeve 71 further has a sleeve side accommodating portion 71b which accommodates the unit 75 therein and communicates with the recessed portion 71d. As shown in FIG. 3A, the sleeve side accommodating portion 71b accommodates the unit 75 therein so that, for example, the distal end surface 75a of the unit 75 can be arranged on the same plane as a bottom surface of the recessed portion 71d when the movable side die 70 is closed to the fixed side die 50. The sleeve side accommodating portion 71b functions as a hole portion into which the unit 75 is fitted and inserted and which pierces through the movable side sleeve 71 along the axial direction of the movable side sleeve 71. The sleeve side accommodating portion 71b is arranged along the axial direction of the movable side die 70. The sleeve side accommodating portion 71b is arranged coaxially with the fixed side accommodating portion 51b so that the unit 75 is arrange coaxially with the fixed side molding die 55. The sleeve side accommodating portion 71b is narrower than the recessed portion 71b. The sleeve side accommodating portion 71b has, e.g., a length which is substantially equal to that of a later-described movable side molding die main body portion 751 of the unit 75.

It is to be noted that, as shown in FIG. 3A, FIG. 3B, and FIG. 3C, the sleeve side accommodating portion 71b has a convex shape which tapers toward the fixed side die 50. In this case, the sleeve side accommodating portion 71b accommodates the unit 75 on a central axis of the sleeve side accommodating portion 71b. Further, the sleeve side accommodating portion 71b also accommodates a defining member 83 and a molding die side energizing member 91 so that the later-described defining member 83 of the projecting mechanism 80 and the later-described molding die side energizing member 91 of the return mechanism 90 surround the unit 75 over the full circumference.

Furthermore, as shown in FIG. 3A, FIG. 3B, and FIG. 3C, the movable side sleeve 71 has a sleeve side ejector insertion opening portion 71e into which a later-described ejector pin 85 of the projecting mechanism 80 is inserted, and a sleeve side return insertion opening portion 71f into which a later-described return pin 93 of the return mechanism 90 is inserted. The sleeve side ejector insertion opening portion 71e and the sleeve side return insertion opening portion 71f are arranged along the axial direction of the movable side die 70. The sleeve side ejector insertion opening portion 71e is arranged coaxially with, e.g., the flow channel portion 17 and the inner flow channel portion 59a. The sleeve side ejector insertion opening portion 71e and the sleeve side return insertion opening portion 71f are arranged on lateral sides of the sleeve side accommodating portion 71b. The sleeve side ejector insertion opening portion 71e and the sleeve side return insertion opening portion 71f function as hole portions.

[Movable Side Backing Plate 73]

As shown in FIG. 3A, FIG. 3B, and FIG. 3C, the movable side backing plate 73 has a backing plate side accommodating portion 73b which accommodates the unit 75. The backing plate side accommodating portion 73b has a convex shape which tapers toward a later-described ejector plate 87 of the projecting mechanism 80. The backing plate side accommodating portion 73b functions as a hole portion into which the unit 75 is inserted and which pierces through the movable side backing plate 73 in the axial direction of the movable side backing plate 73. The backing plate side accommodating portion 73b is arranged along the axial direction of the movable side die 70. A distal end portion of the backing plate side accommodating portion 73b communicates with a proximal end portion of the sleeve side accommodating portion 71 in the axial direction of the movable side die 70. A proximal end portion of the backing plate side accommodating portion 73b communicates with an outside.

It is to be noted that, as shown in FIG. 3A, FIG. 3B, and FIG. 3C, the backing plate side accommodating portion 73b accommodates the unit 75 on a central axis of the backing plate side accommodating portion 73b. Moreover, the backing plate side accommodating portion 73b further accommodates a projecting member 81 and the defining member 83 so that the later-described projecting member 81 of the projecting mechanism 80 is inserted into the backing plate side accommodating portion 73b and the defining member 83 of the projecting mechanism 80 surrounds the unit 75 on the full circumference.

Additionally, as shown in FIG. 3A, FIG. 3B, and FIG. 3C, the movable side backing plate 73 has a backing plate side ejector insertion opening portion 73e into which the ejector pin 85 is inserted, and a backing plate side return insertion opening portion 73f into which the return pin 93 is inserted. The backing plate side ejector insertion opening portion 73e and the backing plate side return insertion opening portion 73f are arranged along the axial direction of the movable side die 70. The backing plate side ejector insertion opening portion 73e is arranged coaxially with, e.g., the flow channel portion 17 and the inner flow channel portion 59a. The backing plate side ejector insertion opening portion 73e and the backing plate side return insertion opening portion 73f are arranged on lateral sides of the sleeve side accommodating portion 71b. The backing plate side return insertion opening portion 73f has a convex shape, and a distal end portion of the backing plate side return insertion opening portion 73f is narrower than a proximal end portion of the backing plate side return insertion opening portion 73f.

It is to be noted that, as shown in FIG. 3A, FIG. 3B, and FIG. 3C, the movable side sleeve 71 is mounted on the movable side backing plate 73 so that the sleeve side accommodating portion 71b communicates with the backing plate side accommodating portion 73b in the axial direction of the movable side die 70, the sleeve side ejector insertion opening portion 71e communicates with the backing plate side ejector insertion opening portion 73e, and the sleeve side return insertion opening portion 71f communicates with the backing plate side return insertion opening portion 73f.

[Unit 75]

As shown in FIG. 3A, FIG. 3B, and FIG. 3C, the unit 75 functions as a bush. The unit 75 is arranged along the axial direction of the movable side die 70. The unit 75 is, e.g., a shaft-like member. The unit 75 is arranged coaxially with the fixed side molding die 55, and faces the fixed side molding die 55. The distal end surface 75a of the unit 75 faces a distal end surface 55a of the fixed side molding die 55. The distal end surface 75a of the unit 75 functions as a transfer surface which transfers the first optical functional surface 11 to the material which forms the molded article 10. It is to be noted that the recessed portion 71d which is the part 711a of the distal end surface 71a of the movable side sleeve 71 is arranged around the distal end surface 75a of the unit 75. The recessed portion 71d functions as a transfer surface which transfers the first edge portion 11a to the material forming the molded article 10.

As shown in FIG. 3A, FIG. 3B, and FIG. 3C, the unit 75 is fitted and inserted into the sleeve side accommodating portion 71b. Thus, a clearance between an outer peripheral surface of the unit 75 and an inner peripheral surface of the movable side sleeve 71 in the sleeve side accommodating portion 71b is extremely small.

As shown in FIG. 3A, FIG. 3B, and FIG. 3C, the unit 75 is accommodated in the sleeve side accommodating portion 71b and the backing plate side accommodating portion 73b so that the unit 75 is projected by the projecting mechanism 80 and the unit 75 returns to a state before projection by the return mechanism 90. The unit 75 is separate from the projecting mechanism 80, and not coupled with the projecting mechanism 80 by, e.g., fastening, fitting, or the like. Thus, the unit 75 can be separated from the projecting mechanism 80 at, e.g., a timing other than projection.

As shown in FIG. 3A, FIG. 3B, and FIG. 3C, such a unit 75 has a movable side molding die main body portion (which will be referred to as a main body portion 751 hereinafter) which molds the molded article 10, and an interposing portion 753 which interposes between the main body portion 751 and the projecting mechanism 80. The main body portion 751 functions as a distal end portion of the unit 75, and the interposing portion 753 functions as a proximal end portion of the unit 75. The interposing portion 753 is separate from the main body portion 751, and can be replaced to the main body portion 751.

[Main Body Portion 751]

As shown in FIG. 3A, FIG. 3B, and FIG. 3C, the main body portion 751 has the distal end surface 75a of the unit 75 which is arranged at a distal end portion of the main body portion 751. The main body portion 751 is, e.g., a shaft-like member. A clearance between an outer peripheral surface of the main body portion 751 at the distal end portion and an inner peripheral surface of the convex sleeve side accommodating portion 71b at the distal end portion is extremely small. The distal end portion of the sleeve side accommodating portion 71b is a region having a minimum diameter in the sleeve side accommodating portion 71b. The distal end portion of the sleeve side accommodating portion 71b communicates with the recessed portion 71d. A diameter of the proximal end portion of the sleeve side accommodating portion 71b is larger than the distal end portion of the sleeve side accommodating portion 71b. The later-described defining member 83 and molding die energizing member 91 are arranged between the proximal end portion of the sleeve side accommodating portion 71b and the proximal end portion of the main body portion 751.

[Interposing Portion 753]

As shown in FIG. 3A, FIG. 3B, and FIG. 3C, the interposing portion 753 has a distal end portion 753a fitted to the main body portion 751, and a proximal end portion 753b having the proximal end surface 75b of the unit 75. The distal end portion 753a is detachably fitted in a groove portion 751c arranged at the proximal end portion of the main body portion 751. Further, an outer peripheral surface of the distal end portion 753a is closely contacted with an inner peripheral surface of the groove portion 751c. This fitting enables the interposing portion 753b to be arranged coaxially with the main body portion 751 and integrated with the main body portion 751. Furthermore, in this embodiment, at the proximal end portion 753b, a proximal end surface of the interposing portion 753 functions as the proximal end surface 75b of the unit 75. The proximal end surface 75b of the unit 75 has a planar shape. The interposing portion 753 is arranged along the axial direction of the movable side die 70. The interposing portion 753 has, e.g., a convex shape.

As shown in FIG. 3A, such an interposing portion 753 is arranged so that the proximal end portion 753b of the interposing portion 753 projects from the backing plate side accommodating portion 73b toward the ejector plate 87 side and the distal end portion 753a of the interposing portion 753 is inserted into the backing plate side accommodating portion 73b when the movable side die 70 is closed to the fixed side die 50. Furthermore, the interposing portion 753 is arranged so that the proximal end portion 753b of the interposing portion 753 is inserted into the sleeve side accommodating portion 71b and the backing plate side accommodating portion 73b when the movable side die 70 is opened to the fixed side die 50 and the interposing portion 753 is projected by the projecting member 81.

Moreover, as shown in FIG. 3A, FIG. 3B, and FIG. 3C, the interposing portion 753 can move along the axial direction of the movable side die 70 to be inserted into the backing plate side accommodating portion 73b and the sleeve side accommodating portion 71b by the projection of the projecting mechanism 80. The interposing portion 753 projects the unit 75 by this movement so that the distal end surface 75a of the unit 75 moves from a bottom surface of the recessed portion 71d toward the fixed side die 50. The projection is performed to, e.g., take out the molded article 10.

[Projecting Mechanism 80]

As shown in FIG. 3A, FIG. 3B, and FIG. 3C, the projecting mechanism 80 detachably abuts on a part of a proximal end surface 75b of the unit 75 so that, for example, the distal end surface 75a of the unit 75 is projected from the distal end surface 71a of the movable side sleeve 71, e.g., the bottom surface of the recessed portion 71d toward the fixed side molding die 55, and the projecting mechanism 80 projects the unit 75 toward the fixed side molding die 55 to the movable side sleeve 71 from the abutting state. Thus, in this embodiment, the projecting mechanism 80 comes into point contact with a part of the proximal end surface 75b of the unit 75 at a time of abutting, and projects the unit 75 to the movable side sleeve 71 by the point contact.

[Projecting Member 81]

As shown in FIG. 3A, FIG. 3B, and FIG. 3C, in this embodiment, the projecting mechanism 80 has the projecting member 81 for projection, and the projecting member 81 has a convex projecting side curved surface portion 81a which comes into point contact with the proximal end surface 75b of the unit 75. The projecting side curved surface portion 81a is arranged at a distal end portion of the projecting member 81. A diameter of the projecting side curved surface portion 81a is gradually reduced toward the proximal end surface 75b. The projecting side curved surface portion 81a comes into point contact only with a proximal end surface of the interposing portion 753 which is the proximal end surface 75b of the unit 75, and it is not fitted or fastened to the proximal end surface 75b. Thus, the projecting member 81 can be separated from the interposing portion 753 by the return mechanism 90. In other words, the projecting side curved surface portion 81a can be separated from the proximal end surface 75b by a thickness of the later-described defining member 83 and the return mechanism 90. As described above, the projecting member 81 is separate from the interposing portion 753. That is, the projecting member 81 is not coupled with the unit 75 including the interposing portion 753 by fastening, fitting, and the like.

As shown in FIG. 3A, FIG. 3B, and FIG. 3C, the projecting member 81 is arranged along the axial direction of the movable side die 70. The projecting member 81 is arranged coaxially with the interposing portion 753. In this embodiment, the projecting member 81 projects the interposing portion 753. The projecting members 81 which are equal to the units 75 in number are arranged, and the projecting member 81 is arranged in accordance with each unit 75. That is, one projecting member 81 projects one unit 75.

[Defining Member 83]

Additionally, as shown in FIG. 3A, FIG. 3B, and FIG. 3C, the projecting mechanism 80 further has the defining member 83 which is arranged on the interposing portion 753 of the unit 75 and defines a position and a projecting amount of the unit 75 to the movable side sleeve 71. The projecting amount of the unit 75 means a moving amount of the interposing portion 753, in other words, a moving amount of the projecting member 81. In this embodiment, the defining member 83 functions as a spacer member so that, for example, the thickness of the defining member 83 defines the projecting amount of the unit 75. The defining member 83 has, e.g., a ring shape.

As shown in FIG. 3A, FIG. 3B, and FIG. 3C, the distal end portion 753a of the interposing portion 753 is inserted into the defining member 83 and fitted to the defining member 83. Thus, the defining member 83 can move along the axial direction of the movable side die 70 together with the interposing portion 753 as described above. Thus, as shown in FIG. 3C, at the time of projection, the defining member 83 is accommodated in the sleeve side accommodating portion 71b, and abuts on the recessed portion 71g of the movable side sleeve 71 in the sleeve side accommodating portion 71b. When the defining member 83 abuts, the defining member 83 defines the projecting amount. The defining member 83 has a plane portion 83a which faces the recessed portion 71g and abuts on the recessed portion 71g on its plane.

As shown in FIG. 3A and FIG. 3B, at the time of molding the molded article 10, the defining member 83 is accommodated in the backing plate side accommodating portion 73b, and abuts on a recessed portion 73g of the movable side backing plate 73 in the backing plate side accommodating portion 73b. When the defining member 83 abuts, the defining member 83 defines a position of the unit 75 to the movable side sleeve 71 at the time of molding the molded article 10. This position is a position before the projection of the projecting mechanism 80 is performed, and also a reference position of the unit 75. The reference position means, e.g., a position at which the distal end surface 75a of the unit 75 is arranged on the same plane as the bottom surface of the recessed portion 71d. The reference position means, e.g., a state before the projection. The defining member 83 has a plane portion 83b which faces the recessed portion 73g and abuts on the recessed portion 73g on its plane.

As shown in FIG. 3A and FIG. 3B, when the unit 75 is placed at the reference position, the plane portion 83a moves away from the recessed portion 71g. At the time of projection shown in FIG. 3C, the plane portion 83b moves away from the recessed portion 73g.

In addition, as shown in FIG. 3A, FIG. 3B, and FIG. 3C, the projecting mechanism 80 further has the ejector pin 85 which is inserted into the backing plate side ejector insertion opening portion 73e and the sleeve side ejector insertion opening portion 71e, and the ejector plate 87 which is arranged to face the movable side backing plate 73 and supports the projecting member 81, the ejector pin 85, and the return pin 93.

[Ejector Pin 85]

As shown in FIG. 3A, FIG. 3B, and FIG. 3C, the ejector pin 85 is, e.g., a rod-like member, and is arranged along the axial direction of the movable side die 70.

[Ejector Plate 87]

As shown in FIG. 3A, FIG. 3B, and FIG. 3C, the ejector plate 87 has a first plate member 87a, and a second plate member 87b which is arranged between the movable side backing plate 73 and the first plate member 87a in the axial direction of the movable side die 70 and mounted on the first plate member 87a. The proximal end portion of the projecting member 81, the proximal end portion of the ejector pin 85, and the proximal end portion of the return pin 93 are arranged on the first plate member 87a. The second plate member 87b has a fitting opening portion 87c into which the projecting member 81 is fitted, an insertion opening portion 87d into which the ejector pin 85 is inserted, and an insertion opening portion 87e into which the return pin 93 is inserted. The projecting member 81 is fitted into the fitting opening portion 87c, the ejector pin 85 is inserted into the insertion opening portion 87d and mounted on the first plate member 87a, and the return pin 93 is inserted into the insertion opening portion 87e and mounted on the first plate member 87a. In this state, the second plate member 87b sandwiches the proximal end portion of the projecting member 81, the proximal end portion of the ejector pin 85, and the proximal end portion of the return pin 93 together with the first plate member 87a, whereby it supports the projecting member 81, the ejector pin 85, and the return pin 93 together with the first plate member 87a.

As shown in FIG. 3A, the ejector plate 87 is pushed by a non-illustrated mechanism when the movable side die 70 is closed to the fixed side die 50. The elector plate 87 moves along the axial direction of the movable side die 70 by pushing, and approaches the movable side backing plate 73. Consequently, the ejector plate 87 pushes the projecting member 81, the ejector pin 85, and the return pin 93 toward the fixed side die 50 along the axial direction of the movable side die 70. Since the elector plate 87 moves along the axial direction of the movable side die 70, a pushing direction of the ejector plate 87 is parallel to the axial direction of the movable side die 70.

Furthermore, as shown in FIG. 3B, when the movable side die 70 is opened to the fixed side die 50, the ejector plate 87 moves away from the movable side backing plate 73 along the axial direction of the movable side die by a later-described ejector side energizing member 95 of the return mechanism 90.

[Return Mechanism 90]

As shown in FIG. 3A, FIG. 3B, and FIG. 3C, the return mechanism 90 returns the unit 75 projected by the projecting mechanism 80 to a state before projection so that the distal end surface 75a of the unit is arranged on the same plane as the distal end surface 71a of the movable side sleeve 71. The state before projection means, e.g., a position at which the distal end surface 75a of the unit 75 is arranged on the left side of the PL, in more detail, on the same plane as the bottom surface of the recessed portion 71d. It is to be noted that the state before projection is desirably set on the basis of, e.g., a shape of the molded article 10.

[Molding Die Side Energizing Member 91]

As shown in FIG. 3A, FIG. 3B, and FIG. 3C, the return mechanism 90 has the molding die side energizing member 91 having an energizing force which energizes the unit 75 in the axial direction of the movable side die 70 through the defining member 83 so that the unit 75 returns to the state before projection. In more detail, the molding die side energizing member 91 is arranged to wind around the proximal end portion of the main body portion 751. The molding die side energizing member 91 is arranged in the sleeve side accommodating portion 71b and the backing plate side accommodating portion 73b. A distal end portion of the molding die side energizing member 91 is fixed to the movable side sleeve 71. A proximal end portion of the molding die side energizing member 91 is fixed to the defining member 83. Such a molding die side energizing member 91 energizes the unit 75 toward the ejector plate 87 through the defining member 83 and the interposing portion 753. Further, the molding die side energizing member 91 energizes the unit 75 so that, for example, the distal end surface 75a of the unit 75 is arranged on the same plane as the bottom surface of the recessed portion 71d, which this arrange is the state before projection. After the molded article 10 is taken out, the molding die side energizing member 91 energizes the unit 75 as described above. It is to be noted that, at the time of energization, the defining member 83 is accommodated in the backing plate side accommodating portion 73b, and abuts on the recessed portion 73g of the movable side backing plate 73 in the backing plate side accommodating portion 73b. When the defining member 83 abuts, the defining member 83 and the molding die side energizing member 91 define the state before projection. That is, the molding die side energizing member 91 energizes the defining member 83 in the axial direction of the movable side die 70 so that the defining member 83 abuts on the recessed portion 73g of the movable side backing plate 73.

As shown in FIG. 3A, FIG. 3B, and FIG. 3C, the molding die side energizing member 91 has, e.g., a coil spring which expands or contracts in the axial direction of the molding die side energizing member 91. For example, the molding die side energizing member 91 functions simultaneously with the later-described ejector side energizing member 95.

Further, as shown in FIG. 3A, FIG. 3B, an FIG. 3C, the return mechanism 90 also has a return pin 93 which is supported by the ejector plate 87 and inserted into the backing plate side return insertion opening portion 73f and the sleeve side return insertion opening portion 71f. Furthermore, the return mechanism 90 also has the ejector side energizing member 95 which is arranged to wind around the return pin 93. The ejector side energizing member 95 has an energizing force which separates the ejector plate 87 including the return pin 93, the ejector pin 85, and the projecting member 81 from the movable side backing plate 73 in the axial direction of the movable side die 70.

[Return Pin 93]

As shown in FIG. 3A, FIG. 3B, and FIG. 3C, the return pin 93 is, e.g., a rod-like member, and is arranged along the axial direction of the movable side die 70.

[Ejector Side Energizing Member 95]

As shown in FIG. 3A, FIG. 3B, and FIG. 3C, the ejector side energizing member 95 has a distal end portion which is inserted into the proximal end portion of the backing plate side return insertion opening portion 73f, and a proximal end portion disposed to the second plate member 87b of the ejector plate 87. The ejector side energizing member 95 has, e.g., a coil spring which expands or contracts in the axial direction of the ejector side energizing member 95.

[Function]

As shown in FIG. 3A, the movable side die 70 is closed to the fixed side die 50 so that the other part 711b of the distal end surface 71a of the movable side sleeve 71 abuts on the other part of the distal end surface 51a of the fixed side sleeve 51.

As shown in FIG. 3A, the ejector side energizing member 95 expands in the axial direction of the ejector side energizing member 95. Furthermore, the ejector side energizing member 95 energizes the ejector plate 87 so that the ejector plate 87 is detached from the movable side backing plate 73 in the axial direction of the movable side die 70. Consequently, the ejector plate 87 including the return pin 93, the ejector pin 85, and the projecting member 81 moves away from the movable side backing plate 73.

Moreover, as shown in FIG. 3A, the molding die side energizing member 91 expands in the axial direction of the molding die side energizing member 91. Additionally, the molding die side energizing member 91 energizes the defining member 83 toward the recessed portion 73g of the movable side backing plate 73 in the backing plate side accommodating portion 73b. When the plane portion 83b of the defining member 83 abuts on the recessed portion 73g of the movable side backing plate 73, the state before projection of the unit 75 including the defining member 83 is stably defined with good reproducibility. Consequently, the distal end surface 75a of the unit 75 is positioned on the same plane as the bottom surface of the recessed portion 71d. The unit 75 returns to the state before projection.

Subsequently, the flow channel portion 17 and the molding cavity portion 15 are defined.

The material molding the molded article 10 is supplied in a molten state from the inner flow channel portion 59a to the molding cavity portion 15 through the flow channel portion 17, and fills the inner flow channel portion 59a, the flow channel portion 17, and the molding cavity portion 15. At the time of filling, since the plane portion 83b of the defining member 83 abuts on the recessed portion 73g, the state before projection of the unit 75 is stably defined with good reproducibility. Thus, filling is performed in a defined state, and precision of the molded article 10 is uniform. When a desired time elapses or cooling is performed, the material is solidified.

As shown in FIG. 3B, the movable side die 70 is opened to the fixed side die 50 so that the distal end surface 71a of the movable side sleeve 71 moves away from the distal end surface 51a of the fixed side sleeve 51.

Further, as shown in FIG. 3C, the ejector plate 87 is pushed by a non-illustrated mechanism, moved along the axial direction of the movable side die 70 by pushing, and approaches the movable side backing plate 73. Consequently, the projecting member 81, the ejector pin 85, and the return pin 93 are pushed out toward the fixed side die 50 along the axial direction of the movable side die 70.

As shown in FIG. 3C, a projecting process is carried out by this pushing. At this projecting process, the unit 75 is projected toward the fixed side die 50 to the movable side sleeve 71 by the projecting mechanism 80 from a state where the projecting mechanism 80 abuts on a part of the proximal end surface 75b of the unit 75 so that the distal end surface 75a of the unit 75 is projected toward the fixed side die 50 from the distal end surface 71a of the movable side sleeve 71. At this time, the projecting member 81 abuts on the interposing portion 753. In more detail, in the projecting member 81, the projecting side curved surface portion 81a comes into point contact with the proximal end surface 75b of the unit 75. Further, the projecting member 81 projects the unit 75 toward the fixed side die 50 through the movable side sleeve 71 from this state.

Here, differing from this embodiment, it is assumed that the unit 75, the projecting member 81, and the ejector plate 87 are integrated with each other. At the time of assembling the movable side die 70, for example, there is a fear that the axial direction of the projecting member 81 is not orthogonally arranged to the plane direction of the ejector plate 87 due to accumulation of machining errors and assembly accuracy of these members, in other words, there is a fear that the axial direction of the projecting member 81 obliquely deviates from the pushing direction of the ejector plate 87. It is to be noted that the pushing direction of the ejector plate 87 is parallel to the axial direction of the movable side die 70 as described above.

In such a case, the unit 75 cannot receive a projecting force directly along the axial direction of the unit 75, but receives a projecting force which is oblique to the axial direction of the unit 75. Thus, there is a fear that the unit 75 does not move along the axial direction of the unit 75 but moves obliquely to the axial direction of the unit 75. If the unit 75 obliquely moves in a state where a clearance between the outer peripheral surface of the unit 75 and the inner peripheral surface of the movable side sleeve 71 (e.g., the sleeve side accommodating portion 71b) is extremely small, there is a fear that the unit 75 abuts on the inner peripheral surface of the movable side sleeve 71. Furthermore, there is a fear that the unit 75 slides on the inner peripheral surface of the movable side sleeve 71 after abutting. Consequently, there is a possibility that the unit 75 is rubbed by sliding, i.e., that galling occurs. In some cases, there is a fear that the unit 75 is not projected and the molded article 10 is not taken out. Moreover, the occurrence of galling leads to a reduction in precision of the molded article 10.

Additionally, as described above, it is assumed that the unit 75, the projecting member 81, and the ejector plate 87 are integrated with each other, differing from this embodiment. There is a fear that, for example, the axial direction of the projecting member 81 is not arranged orthogonally to the plane direction of the ejector plate 87 due to assembly accuracy. In other words, there is a possibility that the axial direction of the projecting member 81 obliquely deviates from the axial direction of the movable side die 70. Consequently, there is a possibility that the unit 75 is accommodated in the movable side sleeve 71 in a state where the unit 75 obliquely deviates from the axial direction of the movable side die 70, in other words, the axial direction of the movable side sleeve 71. There is a fear that, when the unit 75 is projected in this state, as described above, the unit 75 abuts on the inner peripheral surface of the movable side sleeve 71. Thus, as described above, the galling may possibly occur. In some cases, there is a possibility that the unit 75 is not projected and the molded article 10 is not taken out. Additionally, the occurrence of galling leads to a reduction in precision of the molded article 10.

However, in this embodiment, at the time of assembling the movable side die 70, since the interposing portion 753 of the unit 75 is not coupled with the projecting member 81, the above-described point contact is carried out without being affected by the assembly accuracy. The projection based on the point contact is performed along the axial direction of the unit 75, and is not performed obliquely to the axial direction of the unit 75. Thus, the unit 75 moves along the axial direction of the unit 75, and is prevented from moving obliquely to the axial direction of the unit 75. Therefore, the unit 75 is prevented from abutting on the inner peripheral surface of the movable side sleeve 71 in the sleeve side accommodating portion 71b even in a state where the clearance between the outer peripheral surface of unit 75 and the inner peripheral surface of the movable side sleeve 71 is extremely small. Further, the unit 75 is prevented from sliding on the inner peripheral surface of the movable side sleeve 71 which is caused due to abutting. Furthermore, rubbing of the unit 75 due to sliding is prevented, and the occurrence of galling is suppressed. Consequently, the unit 75 is assuredly projected, and the molded article 10 is assuredly taken out. Furthermore, since the occurrence of galling is suppressed, the molded article 10 is highly accurately molded.

It is to be noted that, when the molded articles 10 are taken out at a time, the projecting member 81 is arranged in accordance with each unit 75. Thus, as the assembly accuracy differs depending on each projecting member 81, galling occurs in each unit 75, and the precision of the respective molded articles 10 differs. When the molded articles 10 are taken out at a time, an influence of galling becomes considerable. Furthermore, in this case, the above-described occurrence of galling results in a reduction of precision of the molded article 10.

Even in such a case, the above-described point contact is assuredly performed in accordance with each projecting member 81 in this embodiment. Thus, even if the molded articles 10 are taken out, the occurrence of galling is suppressed, the unit 75 is assuredly projected, the molded articles 10 are assuredly taken out, and the molded articles 10 are highly precisely molded.

It is to be noted that, in the projection, the ejector pin 85 projects the material of the molded article 10 simultaneously with the timing that the unit 75 projects the molded article 10. This material is integral with the molded article 10, and arranged in the inner flow channel portion 59a.

Moreover, in the projection, the defining member 83 moves along the axial direction of the movable side die 70 together with the unit 75. Additionally, the molding die side energizing member 91 is pushed by the defining member 83 and contracted. Further, the defining member 83 abuts on the recessed portion 71g of the movable side sleeve 71 in the sleeve side accommodating portion 71b. When the defining member 83 abuts, the defining member 83 defines the projecting amount.

Further, in the projection, the ejector side energizing member 95 contracts.

It is to be noted, when the molded article 10 is taken out of the movable side die 70, the pushing of the ejector plate 87 by the non-illustrated mechanism is released. Consequently, the ejector side energizing member 95 expands, and the ejector side energizing member 95 detaches the ejector plate 87 from the movable side backing plate 73 along the axial direction of the movable side die 70. The projecting member 81, the ejector pin 85, and the return pin 93 move along the axial direction of the movable side die 70 together with the ejector plate 87.

Furthermore, the molding die side energizing member 91 expands in the axial direction of the molding die side energizing member 91, and energizes the defining member 83 toward the recessed portion 73g of the movable side backing plate 73 in the backing plate side accommodating portion 73b. When the plane portion 83b of the defining member 83 abuts on the recessed portion 73g of the movable side backing plate 73, the unit 75 including the defining member 83 is stably defined to the state before projection with good reproducibility. Consequently, the distal end surface 75a of the unit 75 is positioned on the same plane as the bottom surface of the recessed portion 71d. That is, the unit 75 stably returns to the state before production with good reproducibility.

It is to be noted that the projecting side curved surface portion 81a may be separated from the proximal end surface 75b of the unit 75 on the basis of the thickness of the defining member 83 and an energizing amount of the molding die side energizing member 91.

[Effect]

As described above, in this embodiment, the projecting mechanism 80 abuts on a part of the proximal end surface 75b of the unit 75, and projects the unit 75 toward the fixed side die 50 to the movable side sleeve 71 from the abutting state. Particularly, in this embodiment, the point contact is performed in the abutting.

The projection in the point contact is performed along the axial direction of the unit 75. Thus, in this embodiment, the unit 75 can be moved along the axial direction of the unit 75, and it can be prevented from moving obliquely to the axial direction of the unit 75. Therefore, in this embodiment, even in a state where the clearance between the outer peripheral surface of the unit 75 and the inner peripheral surface of the movable side sleeve 71 is extremely small, the unit 75 can be prevented from abutting on the inner peripheral surface of the movable side sleeve 71. Additionally, in this embodiment, the unit 75 can be prevented from sliding on the inner peripheral surface of the movable side sleeve 71 by abutting. Further, in this embodiment, the unit 75 can be prevented from being rubbed by sliding, and the occurrence of galling can be suppressed. In this embodiment, consequently, the unit 75 can be assuredly projected, and the molded article 10 can be securely taken out. Furthermore, in this embodiment, since the occurrence of galling is suppressed, the molded article 10 can be highly precisely molded.

It is to be noted that, when the molded articles 10 are taken out at a time, in this embodiment, the projecting member 81 is arranged in accordance with each unit 75. Even in such a case, in this embodiment, the above-described point contact is assuredly performed in accordance with each projecting member 81. Thus, in this embodiment, even if the molded articles 10 are taken out, the occurrence of galling can be suppressed, the unit 75 can be assuredly projected, each molded article 10 can be securely taken out, and the molded article 10 can be highly precisely molded.

As described above, in this embodiment, the occurrence of galling can be suppressed, the highly precise molded article 10 can be molded, and the molded article 10 can be securely taken out without being affected by the assembly accuracy.

Furthermore, in this embodiment, the proximal end surface 75b of the unit 75 has the planar shape, and the projecting member 81 has the convex projecting side curved surface portion 81a. Consequently, in this embodiment, the point contact can be assuredly carried out.

Moreover, in this embodiment, the projecting member 81 is arranged in accordance with each unit 75. Thus, in this embodiment, even if the molded articles 10 are taken out at a time, effectiveness is assured.

Additionally, in this embodiment, the main body portion 751 and the interposing portion 753 are arranged, and the interposing portion 753 is separate from the main body portion 751 and replaceable to the main body portion 751. Thus, in this embodiment, replacing the interposing portion 753 enables freely adjusting a shape and a size of the proximal end surface 75b of the unit 75 for the point contact. It is to be noted that the interposing portion 753 may be integral with the main body portion 751. Consequently, the configuration of the unit 75 can be simplified.

Further, in this embodiment, the projecting amount of the unit 75 can be freely defined in accordance with a shape of the molded article 10 by using the thickness of the defining member 83.

Furthermore, in this embodiment, even if the clearance between the outer peripheral surface of the unit 75 and the inner peripheral surface of the movable side sleeve 71 is extremely small, the unit 75 can be returned to the state before projection by the molding die side energizing member 91 and the defining member 83. Consequently, when the molding cavity portion 15 is filled with the material of the molded article 10, retreat of the unit 75 caused due to a pressure of the material can be suppressed, and a molding failure caused in connection with the retreat can be inhibited. Moreover, in this embodiment, the state before projection of the unit 75 can be freely defined in accordance with a shape of the molded article 10 by using the thickness of the defining member 83.

It is to be noted that the number of the fixed side molding dies 55 and the number of the units 75 are the same as the number of the molded articles 10 molded by the molding die 30. The defining member 83 and the molding die side energizing member 91 are arranged in accordance with each unit 75. The ejector pin 85 is arranged in accordance with each flow channel portion 17.

[First Modification]

[Configuration]

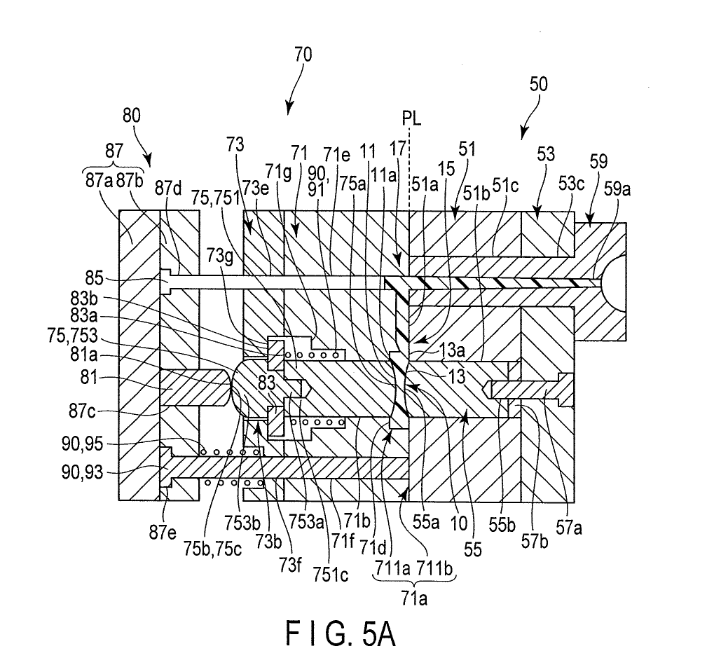

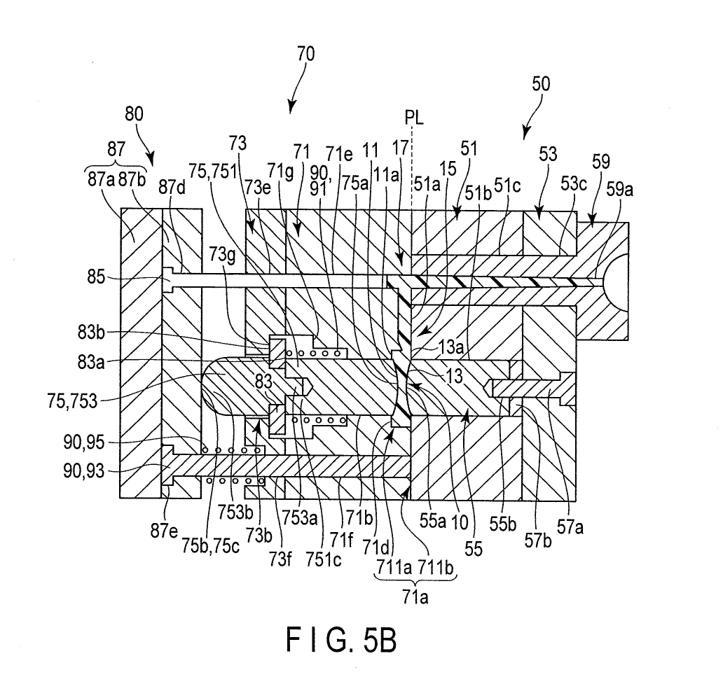

A first modification according to this embodiment will now be described hereinafter with reference to FIG. 5A. In this modification, differences from the first embodiment alone will be described.

The interposing portion 753 of the unit 75 has a convex molding die side curved surface portion 75c which is arranged on the proximal end surface 75b of the unit 75. A diameter of the molding die side curved surface portion 75c is gradually reduced toward the projecting member 81.

In this case, like the first embodiment, the projecting mechanism 80 has the projecting member 81 for projection, and the projecting member 81 has a convex projecting side curved surface portion 81a which comes into point contact with the molding die side curved surface portion 75c. A diameter of the projecting side curved surface portion 81a is gradually reduced toward the proximal end surface 75b. Like the first embodiment, the projecting member 81 is arranged in accordance with each unit 75.

[Effect]

In this modification, the point contact can be assuredly carried out, the occurrence of galling can be suppressed, the unit 75 can be securely projected, and the molded article 10 can be assuredly taken out. Further, in this modification, the molded article 10 can be highly precisely molded.

[Second Modification]

A second modification of this embodiment will now be described hereinafter with reference to FIG. 5B. In this modification, differences from the first embodiment alone will be described.

[Configuration]

The interposing portion 753 of the unit 75 has a convex molding die side curved surface portion 75c arranged on the proximal end surface 75b of the unit 75.

In this case, the projecting mechanism 80 has the ejector plate 87 functioning as a plane portion which comes into point contact with the molding die side curved surface portion 75c. The molding die side curved surface portion 75c comes into point contact with, e.g., a plane of the second plate member 87b. One ejector plate 87 is arranged as a projecting member, and comes into contact with the molding die side curved surface portions 75c of all the units 75.

[Effect]

In this modification, when the molded articles 10 are taken out at a time, the ejector plate 87 which functions as the projecting member does not have to be provided in accordance with each unit 75, and the ejector plate 87 can be shared by the respective units 75. Thus, in this modification, the configuration of the projecting mechanism 80 can be simplified, and the molding die 30 can be made compact and small. Moreover, in this embodiment, the projecting member 81 is no longer necessary, and the molding die 30 can be made compact.

The present invention is not restricted to the foregoing embodiment as it is, and constituent element scan be modified and embodied without departing from a gist of the invention in an embodying stage. Additionally, appropriately combining the constituent elements disclosed in the foregoing embodiment can lead to formation of various inventions.

1. A molding die comprising: a fixed side die; and a movable side die which is arranged to face the fixed side die and is movable to close or open to the fixed side die,
the movable side die comprising:
a movable side sleeve;
a movable side molding die unit which is accommodated in the movable side sleeve, and molds a molded article together with a fixed side molding die of the fixed side die; and
a projecting mechanism which detachably abuts on a part of a proximal end surface of the movable side molding die unit so that a distal end surface of the movable side molding die unit is projected from a distal end surface of the movable side sleeve toward the fixed side molding die, and projects the movable side molding die unit toward the fixed side molding die to the movable side sleeve from an abutting state.

2. The molding die according to claim 1, wherein the projecting mechanism comes into point contact with the part of the proximal end surface of the movable side molding die unit at a time of abutting, and projects the movable side molding die unit to the movable side sleeve by the point contact.

3. The molding die according to claim 2,
wherein the proximal end surface of the movable side molding die unit has a planar shape, and
the projecting mechanism comprises a projecting member for projection having a convex projecting side curved surface portion which comes into point contact with the proximal end surface of the movable side molding die unit.

4. The molding die according to claim 2,
wherein the movable side molding die unit has a convex molding die side curved surface portion which is arranged on the proximal end surface of the movable side molding die unit, and
the projecting mechanism comprises a projecting member for projection having a convex projecting side curved surface portion which comes into point contact with the molding die side curved surface portion.

5. The molding die according to claim 3, wherein the projecting member is arranged in accordance with each movable side molding die unit.

6. The molding die according to claim 5,
wherein the movable side molding die unit comprises:
a movable side molding die main body portion which molds the molded article; and
an interposing portion which comprises a distal end portion fitted to the movable side molding die main body portion and a proximal end portion having the proximal end surface of the movable side molding die unit, and interposes between the movable side molding die main body portion and the projecting mechanism.

7. The molding die according to claim 2,
wherein the movable side molding die unit has a convex molding die side curved surface portion arranged on the proximal end surface of the movable side molding die unit, and
the projecting mechanism has a plane portion which comes into point contact with the molding die side curved surface portion.

8. The molding die according to claim 7, wherein the single plane portion is arranged, and comes into contact with all the movable die side curved surface portions.

9. The molding die according to claim 8,
wherein the movable side molding die unit comprises:
a movable side molding die main body portion which molds the molded article; and
an interposing portion which comprises a distal end portion fitted to the movable side molding die main body portion and a proximal end portion having the proximal end surface of the movable side molding die unit, and interposes between the movable side molding die main body portion and the projecting mechanism.

10. The molding die according to claim 2, wherein the projecting mechanism comprises a defining member which is arranged in the movable side molding die unit and defines a position and a projecting amount of the movable side molding die unit to the movable side sleeve.

11. The molding die according to claim 10, further comprising a return mechanism which returns the movable side molding die unit projected by the projecting mechanism to a state before projection so that the distal end surface of the movable side molding die unit is arranged on the same plane as the distal end surface of the movable side sleeve.

12. The molding die according to claim 1, wherein the return mechanism comprises a molding die side energizing member having an energizing force which energizes the movable side molding die unit through the defining member so that the movable side molding die unit returns to a state before projection.

13. A manufacturing method using the molding die according to claim 1,
the method comprising a projecting process of projecting the movable side molding die unit toward the fixed side molding die by the projecting mechanism to the movable side sleeve from a state where the projecting mechanism abuts on a part of a proximal end surface of the movable side molding die unit so that a distal end surface of the movable side molding die unit is projected toward the fixed side molding die from a distal end surface of the movable sleeve in the movable side molding die unit which is accommodated in the movable side sleeve and molds the molded article.

14. The molding die according to claim 4, wherein the projecting member is arranged in accordance with each movable side molding die unit.

15. The molding die according to claim 14,
wherein the movable side molding die unit comprises:
a movable side molding die main body portion which molds the molded article; and
an interposing portion which comprises a distal end portion fitted to the movable side molding die main body portion and a proximal end portion having the proximal end surface of the movable side molding die unit, and interposes between the movable side molding die main body portion and the projecting mechanism.
